(19) United States
(12) Patent Application Publication
(10) Pub. No.: US 2005/0196568 A1
(43) Pub. Date: Sep. 8, 2005

(54) Multilayer hollow article and method of its production

(76) Inventors: Marc Ollig, Koln (DE); Daniel Baek, Kerpen (DE); Thilo Stier, Niederkassel (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/073,296

(22) Filed: Mar. 4, 2005

(30) Foreign Application Priority Data
Mar. 5, 2004 (EP) 04 005 355.5

(51) Int. Cl. B32B 1/08

(52) U.S. Cl. 428/35.7; 264/573

(57) ABSTRACT

The present invention relates to a method for the production of a multilayer hollow body, said method comprising successive injection of at least two different molding compounds into a mold, followed by introduction of a compressed fluid, at least one of the molding compounds employed containing a filled or non-filled high-temperature polymeric material. Furthermore, the present invention relates to a multilayer hollow body which can be obtained by means of the method according to the invention.

### BACKGROUND OF THE INVENTION

The present invention relates to multilayer hollow bodies and to a method for the production thereof.

A multilayer hollow body is a wall formed by several layers, which wall encloses one or more interconnected cavities. Inter alia, such hollow bodies are used as media lines to convey a wide variety of mostly liquid or gaseous media. For example, they can be designed in the form of tube-like hollow bodies and can include additional connections and functional elements.

To produce single-layer hollow bodies, especially in the form of a tube, mainly the gas injection technology and fluid injection technology are known, in particular, e.g. from DE 40 11 310 A1 and DE 199 03 682 A1, as well as the gas injection technology using supercooled gases. A common feature of the above methods is that a flowable molding compound is injected into the mold cavity of an injection mold in such a way that the cavity is filled either completely or only in part. Using a compressed fluid, which is a gas such as air, carbon dioxide or nitrogen in the gas injection technology (GIT) and a liquid such as water (water injection technology, WIT) or an oil in the fluid injection technology (FIT), the core of the molding compound—still in fused state—is displaced in a way so as to become uniformly distributed on the wall of the mold cavity, excess molding compound being discharged e.g. through openings or distributed in a side cavity in case the cavity is completely filled with molding compound. There are numerous process variants and devices, particularly for use in the gas injection technology. While DE 199 03 682 A1 mentions that the water injection technology is also capable of producing multilayer hollow bodies by injecting different molding compounds, there is no further information as to details of process technology or suitable materials.

Each of the two above-mentioned methods has its advantages and drawbacks, which is why their fields of use are different. The highly different viscosities of the melt to be displaced and the gas impede displacement of the molding compound, which is why the gas injection technology particularly yields thick-walled, tubular components having a relatively small diameter. In contrast, when using the water injection technology, for example, it is also possible to obtain components having smaller residual wall thickness and larger diameter.

The significantly higher heat capacity of water compared to gases also contributes to the fact that WIT enables production of components having larger diameter and, at the same time, smaller residual wall thickness. In contrast, the production of components with larger diameter in GIT results in relatively slow cooling of the molding compounds due to inferior heat dissipation, which therefore run down along the mold wall, thereby possibly giving rise to varying residual wall thickness and irregularities in the resulting cooled hollow body.

Moreover, when producing components having sharp curvatures (e.g. acute 90° deflections or 180° bends), it should be considered that this may give rise to varying wall thicknesses across the component. Suitable selection of the influencing factors such as water pressure, holding time and temperature can achieve improved centering of the cavity in and after curvatures in the WIT. In contrast, however, when compared to the GIT, removal of the water being a compressed fluid, from the curved areas after cooling the resulting wall of the hollow body is more complicated in this technology.

GIT and WIT are widely used when producing media ducts, e.g. in the automotive sector. Thus, radiator hoses are frequently produced by means of such technologies. These predominantly tubular components frequently have branchings and relatively sharp bends, possibly in different spatial planes, giving rise to the above-mentioned problems during the manufacture thereof.

Moreover, great demands are being made on the materials used for the above purposes. Firstly, the materials must be durably stable with respect to the substances flowing therethrough. They should neither be unduly attacked by the media flowing through, nor—as a result of their nature—allow abrasion of surface particles and entrainment with the flowing medium in case of frequent flow. The water/glycol mixture frequently used in this sector has been found highly aggressive, usually requiring stabilization of the materials forming the wall, which is frequently associated with high expenditure of apparatus and cost.

Further, there are always temperature fluctuations with high maximum values. The materials employed must therefore be stable with respect to temperature. Moreover, the components should have mechanical strength to some extent so as to ensure constant positioning in the place of use, e.g. in an automobile.

While materials usable in media lines, e.g. heat-stabilized polypropylene, including ethylene-propylene-diene terpolymer (EPDM), are remarkable for their good resistance to temperature and media, such as hot water resistance, they have only limited ability to withstand mechanical stress. For this reason, high-temperature materials such as polyamides preferably have been used for such purposes, which, in order to achieve improved mechanical strength, are filled with glass fibers, for example.

While components produced from such materials have good temperature resistance within the required ranges, they frequently necessitate costly stabilization to hydrolysis in order to ensure resistance to media, such as coolants, flowing therethrough.

In addition, the melts of the high-temperature materials employed, such as polyamide, tend to rapid solidification, especially when using compressed fluids with a strong cooling effect, e.g. water or cooled inert gases such as nitrogen or carbon dioxide, during the production process. Due to the interior portion of the molding compound undergoing more rapid solidification and being in contact with the compressed fluid, using such materials frequently results in the formation of voids in the wall, which may form a mechanically weak spot. Also, rapid—and therefore non-uniform—solidification of the molding compound gives rise to surface roughness to some extent, thus causing an increased flow resistance. In addition, steady flow of e.g. a coolant, sometimes even for a longer period of time, through tubes accordingly produced can result in undesirable abrasion of the inner surface of the tube and distribution of the tube material to other areas, e.g. of an automobile, thus causing concomitant damage. In particular, this applies in those cases where the material forming the wall is filled with glass fiber which is partially washed out in the course of time.

To avoid such problems, current advanced developments are aimed at improving the materials being used, e.g. by means of retarding additives and glass fiber-mineral mixtures. However, this is usually associated with higher cost and sometimes with extreme expenditure of apparatus.

### SUMMARY OF THE INVENTION

The present invention is therefore based on the object of providing a hollow body which, in particular, is suitable for conveying media and avoids the above-mentioned drawbacks. Another object is to provide a method for the production of a hollow body which, in particular, is suitable for conveying media and avoids the above-mentioned drawbacks.

Said object is accomplished by means of a method for the production of a multilayer hollow body, in which method at least two different molding compounds are injected into a mold one after the other, followed by introduction of a compressed fluid, at least one of the molding compounds employed containing a filled or non-filled high-temperature polymeric material. In addition, said object is accomplished by means of a multilayer hollow body which can be obtained by means of the method according to the invention.

### DETAILED DESCRIPTION OF THE PREFERRED EMBODIMENTS

The present multilayer hollow body is a wall formed by several layers, said wall enclosing one or more interconnected cavities. Furthermore, the hollow bodies may have additional functional elements such as domes, fastening elements, straps, and inserts. The present multilayer hollow bodies are preferably tubular components, especially for use as media lines, e.g. in the automotive sector, such as radiator hoses. Use thereof as oil hoses, water pipes, high-pressure water pipes, fuel oil pipes, and in the domestic sector is also possible. The tubular components can have one or more identical or different curvatures, the angle of curvature not being particularly restricted, and the curvatures can be present in the same or different spatial planes. For example, 90° deflections or 180° bends are also possible. In addition, the tubes can be branched.

The type of medium flowing e.g. through media lines in the form of hollow bodies is not particularly restricted; however, the medium should not excessively attack the wall material contacting it. In the event of radiator hoses as media lines, a water/glycol mixture may flow through the multilayer media lines, for example. Furthermore, oil, water, including waste water, (dilute) cleaners, and alkaline solutions represent usual media flowing through such lines.

Such multilayer hollow bodies can be obtained by means of injection molding processes wherein a compressed fluid is used to form the cavity. Preferably, such processes comprise gas injection technology, sometimes using supercooled gases, fluid injection technology or, in particular, water injection technology, as known from the prior art, involving successive injection of two or more different flowable molding compounds into a mold corresponding to the shape of the hollow body to be formed (preferably through the same injection point), followed by introduction of the compressed fluid. Depending on the use of the hollow body, the compressed fluid may remain in the hollow body after cooling of the molding compounds, or can be removed therefrom. In the production of media lines having at least two open ends, the compressed fluid can be removed when forming the ends. When using liquids as compressed fluid, a subsequent drying step is possible in addition, using e.g. a flowing gas or air.

Another variant is previous introduction of gas or air to form the cavity and subsequent rinsing with water.

At least one molding compound containing a filled or non-filled high-temperature polymeric material is used in the production of the present multilayer hollow bodies.

The high-temperature material in the present application is understood to be a material which is dimensionally stable to a great extent at operating temperatures of from −80° C. to +330° C., preferably from −50° C. to +300° C., and more preferably from −40° C. to +250° C. Furthermore, the fused high-temperature materials preferably used herein tend to undergo rapid solidification.

More specifically, one advantage in the production of multilayer hollow bodies wherein at least one layer contains such a high-temperature polymeric material is that cooling of the high-temperature material is not effected exclusively via the compressed fluid, but rather, the molding compound containing said material, while still in a flowable state, is in contact with another fused or already slightly cooled molding compound. As a result, the temperature difference between the outer and inner regions of a layer is smaller, and cooling of the inner region of a layer is not dramatically more rapid compared to the outer region of the layer. Cooling is therefore much more uniform across a substantial region of the layer thickness. In this way, formation of voids, as well as roughness of the inner surface is reduced. At the same time, entrainment of small particles from the inner surface of the hollow body is reduced when liquid media flow through during use.

Independently of the type of molding compound(s) used in addition to the molding compound containing the high-temperature material, the properties of the resulting hollow bodies with respect to weak spots caused by voids and/or with respect to surface roughness are improved merely by performing the method of producing multilayer hollow bodies as compared to single-layer hollow bodies. This effect is particularly apparent when using the fluid injection technology or, in particular, the water injection technology, but is also present when using the internal gas pressure technology with supercooled gases.

This effect is even increased when using a material as inner molding compound which undergoes significantly slower solidification than the fused high-temperature material. In this way, particularly uniform cooling of outer layer(s) and inner layer and thus a particularly smooth inner surface is achieved.

At least two different molding compounds are used to produce the multilayer hollow body. For example, such difference results from using a completely different ingredient, or by using the same ingredient which is produced or processed in a special manner or includes different additives or the same additives in different amounts, so that the layers produced from such molding compounds would have different properties. Thus, for example, it is possible that the same ingredient merely is present in a different modification, or is filled with a different filler, or includes the same filler with a different quantity.

The number of different molding compounds employed is determined by the demands on the hollow body. Conventionally, hollow bodies preferred to have a relatively small residual wall thickness and/or small cross-section therefore consist of a smaller number of layers than hollow bodies having larger diameter and/or larger residual wall thickness. Furthermore, the number and type of molding compounds used are determined by the desirable properties of the hollow body. Thus, for example, outer layers or inner layers intended to provide sealing for protection from substances contacting the hollow body are possible. In a preferred fashion, the multilayer hollow body comprises two, three or four, more preferably two layers.

At least one of the molding compounds includes a filled or non-filled high-temperature polymeric material.

In addition to said filled or non-filled high-temperature polymeric material, the molding compound optionally includes up to 70 wt.- %, preferably up to 50 wt.- %, of other conventional components such as fillers, stabilizers, dyes, pigments and lubricants.

The high-temperature material is preferably a polymer selected from the group comprising polyamides (PA), polyalkylene terephthalates, filled polyolefins or mixtures thereof, in which mixtures the polyolefin can also be non-filled. In a preferred fashion, filled or non-filled polyamides, filled or non-filled polyalkylene terephthalates, filled polyolefins or mixtures thereof, preferably mixtures of said filled or non-filled polyamides with non-filled polyolefins are employed.

In addition, the polyamides may include aromatic residues. Examples of polyamides preferably used are PA 6, PA 66, PA 4.6, PA 12, polyphthalamide (PPA) or mixtures thereof.

In a preferred fashion, polyethylene terephthalate (PET), polybutylene terephthalate (PBT), poly(1,1-cyclohexanedimethylene terephthalate) or mixtures thereof are used as polyalkylene terephthalate. Particularly preferred is the use of PBT.

For example, the polyolefin can be selected from the group comprising polyethylene (PE), polypropylene (PP) and mixtures thereof. In a particularly preferred fashion, polypropylene is used. In those cases where said polyolefin, particularly polypropylene, is not used in a combination with one of the additional high-temperature materials mentioned above, but represents the only polymer in the molding compound, it will be filled so as to ensure improved mechanical strength, temperature resistance and dimensional stability.

The high-temperature material can be filled with one or more fillers preferably selected from the group comprising glass fibers, mineral fibers and minerals. For example, E or S glass fibers known from the prior art can be used as glass fibers. One example of a suitable mineral fiber is wollastonite. Minerals that can be used are, for instance, calcium carbonate, e.g. in the form of chalk, barium sulfate, mica, talc or kaolin. In a preferred fashion, glass fibers are used.

The filler content preferably ranges from 0 to 85 wt.- %, relative to the filled polymer, more preferably from 10 to 50 wt.- %, with a range of from 20 to 40 wt.- % being particularly preferred. Similarly, the glass fiber content is preferably between 0 and 60 wt.- %, relative to the filled polymer, more preferably 10 and 50 wt.- %, with 20 to 40 wt.- % being particularly preferred.

In a particularly preferred embodiment, a mixture of glass fiber-filled PA, especially PA66 or PA6, and PP is used. The content of PP is preferably 0 to 80 wt.- %, relative to the total amount of PA and PP, more preferably 30 to 70 wt.- %, with 40 to 50 wt.- % PP being particularly preferred. The glass fiber content is within the ranges mentioned above.

A particularly advantageous embodiment includes a mixture of PA66 and PP (PP content within the ranges mentioned above) with 30 to 45 wt.- %, particularly 35 wt.- % glass fibers as outer layer and PP with 15 to 25 wt.- %, particularly 20 wt.- % glass fibers as inner layer.

In a particularly advantageous fashion, a layer containing a high-temperature material will not form the inner layer of the multilayer hollow body being produced. This avoids direct contact of the high-temperature materials with e.g. a medium flowing through a tubular hollow body. This is particularly important in those cases where the high-temperature material is per se unstable to the medium flowing through. In this event, stabilization of the high-temperature material forming the inner layer would be sensible or required. However, this can be associated with high expenditure of apparatus or cost. In contrast, when selecting a material as inner layer which is per se resistant to the medium flowing through, there is no need of stabilizing the inner layer.

Thus, when using the multilayer hollow body as a radiator hose in the automotive sector, for example, the fact must be considered that filled or non-filled polyamides employed as high-temperature material are not resistant to a water/glycol mixture. In those cases where the inner layer actually consists of such a material, the polyamide should be made resistant to hydrolysis to ensure longer useful life of the hose.

The molding compound not forming the inner layer can also contain a recycled polymer. In this event, the layer containing the recycled polymer does not make direct contact with a medium flowing through the hollow body and therefore, the quality of the recycled product has no influence on the resistance of the multilayer hollow body to the medium flowing through.

In another preferred embodiment, the multilayer hollow body is formed of two or more molding compounds, at least two adjacent ones of which containing the same filled polymer or the same mixture of polymers, but with different filler content, at least one of said polymers being filled. As a result, the adhesion between the two layers is significantly enhanced compared to the use of completely different polymers in the molding compounds. In this context, it is possible that the inner layer has a higher filler content, but it may also be the case that the outer layer has a higher filler content. The difference of such varying filler contents is not particularly restricted; preferably, however, it should be at least 5 wt.- %, more preferably at least 15 wt.- %, and especially preferably at least 30 wt.- %. In a particularly advantageous embodiment, it is the outer layer that has the higher filler content.

In another advantageous embodiment, the multilayer hollow body is formed of two or more molding compounds, at least two adjacent ones of which containing the same filled polymer or the same mixture of polymers with the same filler content but different types of fillers, at least one of said polymers being filled. As a result of using the same polymer in at least two adjacent layers, there is enhanced binding between these layers compared to adjacent layers formed of completely different polymers.

Other polymers which, in addition to the high-temperature polymeric materials, are capable of forming one or more layers of the multilayer hollow body are e.g. polyacetals, non-filled polyolefins or mixtures thereof. The polyolefin being used is preferably polyethylene, polypropylene or a mixture thereof. In a preferred fashion, poly(oxymethylene) can be used as polyacetal.

In a particularly advantageous embodiment, the inner layer of the multilayer hollow body is formed by one of said polymers, and in a particularly preferred fashion polypropylene is used. Specifically when using the multilayer hollow body as radiator hose in the automotive sector, polypropylene is highly useful as material for the inner layer because of its resistance to the water/glycol mixture used as coolant. In non-filled form, however, it is not temperature-resistant with respect to its dimensional stability. Its use as the only outer layer would give rise to deformation of the latter, e.g. when media with elevated temperature flow through the hollow body, such deformation being undesirable during use.

For this reason, at least one of the outer layers should be formed of a high-temperature material so as to ensure mechanical strength of the hollow body. Deformation of the inner layer in this case is less problematic, because the inner layer, as a result of the pressure generated when a liquid medium flows through, is pressed outwardly until it reaches the wall of the hollow body, thus constituting a boundary, and makes close contact therewith.

In addition, an inner layer resistant to a medium flowing through the hollow body is advantageous in that an outer layer possibly not resistant to said medium does not require stabilization because it does not come in contact with the medium. This can save both technical effort and costs.

Especially when using the multilayer hollow body as a radiator hose in the automotive sector, non-filled polypropylene, in addition to filled or non-filled polyamide made resistant to hydrolysis, is therefore the preferred material used to form the inner layer.

A particularly preferred embodiment includes a mixture of PA, especially PA66 or PA6, and PP with 30 to 45 wt.- %, particularly 35 wt.- % glass fibers as outer layer and non-filled PP as inner layer, the content of PP in the outer layer preferably being 0 to 80 wt.- %, relative to the total amount of PA and PP, more preferably 30 to 70 wt.- %, and especially preferably 40 to 50 wt.- % PP.

As the inner layer is pressed outwardly when a medium flows through, there are no high demands on the connection between the inner layer and outer layer when using a high-temperature material in at least one of the outer layers. However, enhanced binding between the inner layer and outer layer is not disadvantageous either.

Gaseous or liquid substances can be used as compressed fluid, especially those known from the prior art relating to such methods. For example, these include air, inert gases such as nitrogen or carbon dioxide, or liquid media such as water or oils or mixtures thereof. Liquid compressed fluids in particular may include additional substances facilitating formation of the hollow body or improving the properties thereof, especially the surface properties. In a preferred fashion, a liquid compressed fluid is used, preferably water.

### EXAMPLES

Without intending to be limiting, preferred embodiments will be explained in more detail with reference to the following examples. Unless otherwise stated, all percentages relate to weight percents hereinafter.

### Comparative Example

Using the water injection technology, a cooling water tube is produced from polyamide 66 made resistant to hydrolysis and filled with 35 wt.- % glass fibers, relative to the filled polymer. The strong cooling effect of the compressed fluid is found to result in void formation in the wall, constituting a mechanically weak spot. The inner surface appears slightly rough. As a result of the constant flow of medium (water/glycol at a ratio of 50/50 w/w), entrainment of small particles is observed with time, which must be filtered out in order to avoid damage.

### Examples According to the Invention

In analogy to the comparative example, a cooling water tube comprising a plurality of layers is produced according to Table 1, using the water injection process. In the co-injection process, the outer layer is the first component to be injected. The inner layer is injected as second component through the same injection point. The cavity is formed by final blow molding of the core, which is still in fused state, using water as compressed fluid. The quality of the inner surface is determined visually and haptically.

TABLE 1

| | | Second layer |
|---|---|---|
| | First layer (outer layer) | (inner layer) |
| 1 | PA 6/PP (60/40 w/w) (35% glass fibers) | PP |
| 2 | PA 66/PP (60/40 w/w) (35% glass fibers) | PP |
| 3 | PA 66/PP (60/40 w/w) (35% glass fibers) | PP (20% |
| | | glass fibers) |
| 4 | PA 66 (35% glass fibers) | PA 66 (hydrolysis- |
| | | resistant, non-filled) |
| 5 | PA 66 (35% glass fibers, recycling quality) | PA 66 (hydrolysis- |
| | | resistant, non-filled) |
| 6 | PA 4.6 (35% glass fibers) | PP |

PA = polyamide,
PP = polypropylene

In all cases, high smooth quality was achieved on the inner surface. No abrasion of particles from the surface of the cooling water tube was detected after prolonged use (>5000 hours). Formation of voids was not observed. As can be seen from Example 4, the recycled material quality of the outer layer has no influence on the resistance of the multilayer hollow body to the medium flowing through. In all cases, no particles abraded from the inner surface were observed after 5000 hours of water/glycol (50/50 w/w) flow through the cooling water tube.

1. A method for the production of a multilayer hollow body, comprising successive injection of at least two different molding compounds into a mold, followed by introduction of a compressed fluid, at least one of the molding compounds employed containing a filled or non-filled high-temperature polymeric material.

2. The method according to claim 1, wherein the high-temperature material is selected from the group comprising polyamides (PA), polyalkylene terephthalates, filled polyolefins or mixtures thereof, in which mixtures the polyolefin can also be non-filled.

3. The method according to claim 2, wherein the polyamide comprises aromatic residues.

4. The method according to claim 2, wherein the polyamide comprises a material selected from the group consisting of PA 6, PA 66, PA 4.6, PA 12, polyphthalamide (PPA), or mixtures thereof.

5. The method according to claim 2, wherein the polyalkylene terephthalate comprises a material selected from the group consisting of polyethylene terephthalate (PET), polybutylene terephthalate (PBT), poly(1,1-cyclohexane-dimethylene terephthalate) or mixtures thereof

6. The method according to claim 2, wherein the polyolefin comprises a material selected from the group consisting of polyethylene (PE), polypropylene (PP) and mixtures thereof.

7. The method according to claim 1, wherein a mixture of filled PA and PP is used as high-temperature polymeric material.

8. The method according to claim 1, wherein the high-temperature material is filled with one or more fillers selected from the group consisting of glass fibers, mineral fibers and minerals.

9. The method according to claim 1, wherein a filler content is 0 to 60 wt.- %, relative to filled polymer.

10. The method according to claim 1, wherein the multilayer hollow body is formed of two or more molding compounds, at least two adjacent ones of which contain the same filled polymer or the same mixture of polymers but with different filler content, at least one of said polymers being filled.

11. The method according to claim 1, wherein the multilayer hollow body is formed of two or more molding compounds, at least two adjacent ones of which contain the same filled polymer or the same mixture of polymers with the same filler content but different types of fillers, at least one of said polymers being filled.

12. The method according to claim 1, wherein a molding compound containing a high-temperature material does not form the inner layer of the hollow body.

13. The method according to claim 1, wherein at least one of the molding compounds comprises a polymer selected from polyacetals, non-filled polyolefins or mixtures thereof.

14. The method according to claim 13, wherein the non-filled polyolefin is selected from the group consisting of polyethylene, polypropylene or mixtures thereof.

15. The method according to claim 13, wherein poly(oxymethylene) is used as polyacetal.

16. The method according to claim 13, wherein polypropylene forms the inner layer.

17. The method according to claim 1, wherein the multilayer hollow body is formed of at least two different molding compounds and the polymer components of an outer layer molding compound contain 5 to 95 wt.- % of the polymer components of the adjacent inner layer molding compound and 95 to 5 wt.- % of filler.

18. The method according to claim 1, wherein a molding compound not forming an inner layer contains a recycled polymer.

19. The method according to claim 1, wherein the compressed fluid is in liquid or gaseous form.

20. The method according to claim 1, wherein the compressed fluid is an inert gas.

21. The method according to claim 1, wherein the compressed fluid is selected from the group consisting of air, N₂, CO₂, water and oil.

22. A multilayer hollow body formed by the method of successive injection of at least two different molding compounds into a mold, followed by introduction of a compressed fluid, at least one of the molding compounds employed containing a filled or non-filled high-temperature polymeric material.
